(19) United States
(12) Patent Application Publication
(10) Pub. No.: US 2001/0001090 A1
(43) Pub. Date: May 10, 2001

(54) Method for transmitting data from mobile stations to other parts of a mobile communication system, providing the mobile station with means for independently at predetermined moments send data on a predetermined channel

(75) Inventor: Arto Harjula, Espoo (FI)

Correspondence Address: Michael B. Lasky, Altera Law Group, 6500 CITY WEST PARKWAY, SUITE 100, Minneapolis, MN, 55344-7701, US

(73) Assignee: Nokia Networks Oy

(21) Appl. No.: 09/733,191

(22) Filed: Dec. 8, 2000

Related U.S. Application Data
(63) Continuation of application No. PCT/FI00/00368, filed on Apr. 27, 2000.

(30) Foreign Application Priority Data
Apr. 30, 1999 (FI) 990995

(51) Int. Cl. H04Q 7/20

(52) U.S. Cl. 455/456; 455/450; 455/466; 701/207; 701/217; 701/213; 701/300; 340/988

(57) ABSTRACT

The invention relates to a mobile communication system including mobile stations comprising transmission means for sending data over the radio path, at least one mobile exchange, and base stations having a data transmission connection with the mobile exchange, traffic channels being allocated to be used by transceiver units of the base stations for providing calls to the mobile stations, the base stations also comprising means for receiving the data sent by the mobile stations over the radio path and for forwarding said data to other parts of the system. In order for the mobile stations to be able to send data more efficiently, at least one predetermined data channel is allocated for the mobile stations to send data. In addition the system includes at least one mobile station comprising control means that independently at predetermined moments control the transmission means of the mobile station to move over to said predetermined data channel for the time the data is sent, in which case the mobile station sends said data on said data channel without a preceding channel allocation.

1. The invention relates to a mobile communication system in which mobile stations send predetermined data over the radio path. The invention relates to a mobile communication system in particular, in which said data is formed of data describing the location of the mobile stations. In the following the invention is primarily described in connection with a system where the data sent by the mobile stations describes the location thereof. However, it should be noted that the invention is not restricted to this particular embodiment but can also be utilized for transmitting other forms of data, such as various types of telemetry data (for example, water level elevation or traffic density on high-ways).

2. Such mobile communication systems are previously known in which the mobile stations send data describing the location thereof over the radio path to other parts of the system. There are several alternative solutions that enable the mobile stations to determine their specific location. In one known solution a receiver of a positioning system, such as a Global Positioning System (GPS) receiver, is integrated into a mobile station. The data describing location, or location data, received from the mobile stations can, in turn, be employed for various applications. One alternative is to monitor the location of a particular vehicle, such as a bus or a lorry, by means of the location data, in which case a map on a computer display allows to continuously observe the movements of a particular bus.

3. A problem associated with prior art mobile communication systems relates to the transfer of data over a radio interface from a mobile station to the base stations of the system, In known solutions data is transferred over the radio interface, for example, such that the mobile stations send data messages including location data on a calling channel of the mobile communication system. However, such a solution loads the calling channel excessively, as the amount of data to be transferred is very large. Consequently this prior art solution is applicable to be used only if the number of mobile stations to be monitored is very small.

4. Another known solution for transmitting data including location data is to establish a connection from the mobile station to the base station in order to send data using a traffic channel which is available to be used by the base station. However, said solution provides a very large amount of calls with a short duration, which is why a significant portion of the base station traffic capacity is constantly, or nearly constantly, used only for transferring location data. In addition, this known solution allocates the mobile station transceiver unit for a substantially long time.

5. It is an object of the invention to solve the above problems and to achieve a solution that enables to transfer data more efficiently from a mobile station to other parts of the system without loading the mobile communication system excessively or allocating individual mobile stations for a substantially long time. This object is achieved with a method of the invention for transmitting data from mobile stations to other parts of a mobile communication system in the mobile communication system comprising base stations having a data transmission connection with a mobile exchange and mobile stations comprising transmission means for sending data. The method of the invention is characterized by comprising the steps of allocating at least one predetermined data channel from the system for sending said data over the radio path from the mobile stations to the base stations, providing at least one mobile station with control means that independently at predetermined moments control the mobile station to send data on said data channel without a channel allocation preceding the transmission, and providing at least one of the base stations in the system with means for receiving the data sent on said data channel and for forwarding said data to the other parts of the system.

6. It is further an object of the invention to provide a mobile communication system that enables a more efficient transfer of data from a mobile station to other parts of a mobile communication system, the system being able to utilize the method of the invention. This object is achieved with a mobile communication system including: mobile stations comprising transmission means for sending data over the radio path, at least one mobile exchange, and base stations having a data transmission connection with the mobile exchange, traffic channels being allocated to be used by transceiver units of the base stations for providing calls to the mobile stations, the base stations also comprising means for receiving the data sent by the mobile stations over the radio path and for forwarding said data to other parts of the system. The mobile communication system of the invention is characterized in that at least one predetermined data channel is allocated in the system for the mobile stations to send data, and in that the system includes at least one mobile station comprising control means that independently at predetermined moments control the transmission means of the mobile station to move to said predetermined data channel for the time data is sent, in which case the mobile station sends said data on said data channel without a preceding channel allocation.

7. The invention is based on the idea that when a particular data channel is introduced into a mobile communication system for transmitting data from mobile stations to other parts of the system, data is transmitted without significantly loading the system. It may be preferable in some systems to allocate more than one data channel for said purpose, but resources can significantly be saved in the system already by using one specific data channel. On account of a specific data channel the calling channel does not have to be unnecessarily loaded, since the mobile stations can independently conclude the time when they send the data describing location on the channel allocated for said purpose. What is referred to by independently concluding the transmission time in this context is that the system does not have to separately indicate the transmission time for each individual mobile station.

8. As the mobile stations are able to send the data describing the location thereof without a channel allocation preceding the transmission (i.e. the mobile stations do not have to reserve a channel from the base station in advance), and since an acknowledgement about receiving the data does not have to be sent to the mobile stations, the data can be very rapidly and easily transmitted.

9. It is possible that two mobile stations located close to one another simultaneously send data on the data channel allocated for this purpose. Simultaneous transmission may cause such significant interferences that the base stations of the system cannot receive the data of either mobile station. Therefore the data sent by either mobile station in question cannot be received. When said data includes data describing the location of the mobile stations the drawbacks of the colliding situation explained above can be minimized, if the mobile stations are originally programmed to send location data fairly frequently, i.e. for example 2 to 3 times per minute.

10. The most significant advantages of the solution of the invention are that mobile stations are able to send data without significantly loading the traffic or calling channels of the mobile communication system, and that the transmission of data from the mobile station is a very rapid operation that allocates the mobile station transmitter for a very short time.

11. In a preferred embodiment of the mobile communication system of the invention at least one of the base stations comprise: at least one transceiver unit arranged to use said data channel for receiving the data sent by the mobile stations, transceiver units arranged to use the traffic channels allocated for said base station for transmitting calls between the mobile stations located within the coverage area of the base station and the mobile exchange, monitoring means arranged to monitor the traffic load of the transceiver units using the traffic channels, and control means for controlling the transceiver unit employing the data channel to use the traffic channel allocated to the base station, when the monitoring means indicate that the traffic load of the base station exceeds a predetermined limit, and for controlling the transceiver unit released from traffic use to use the data channel, when the monitoring means indicate that the released transceiver unit is not needed to be used on the traffic channel.

12. The above preferred embodiment of the mobile communication system of the invention allows the transceiver unit receiving the data sent on the data channel of the mobile station to be allocated, if needed, for traffic use in such a manner that calls can, for example, be transmitted to the mobile stations through the transceiver unit. However, in this case said base station is no longer able to receive the data sent on the data channel of the mobile stations, but data is transmitted to the system only through the other available base stations. When one of the transceiver units in traffic use is released, the control means of the base station direct said transceiver unit to the data channel, and the base station is again able to receive data from the data channel. The monitoring means may inform the control means that the transceiver unit to be released is not needed for traffic channel use always when all the transceiver units of the base station employ the traffic channels allocated to the base station, in which case the first transceiver unit to be released will be controlled by the control means to receive the data sent on the data channel.

13. In another preferred embodiment of the mobile communication system of the invention, a GPS receiver is integrated into the mobile stations for providing data describing location. The system may then comprise a base station which sends DGPS (Differential Global Positioning System) data to the mobile stations on the calling channel or control channel in use. This preferred embodiment of the invention ensures that the location data of the mobile stations is more accurate than previously.

14. The preferred embodiments of the method and the system of the mobile communication system according to the invention are disclosed in the appended dependent claims 2 to 5 and 7 to 15.

15. In the following the invention is described by way of example in greater detail by reference to the attached drawings, in which:

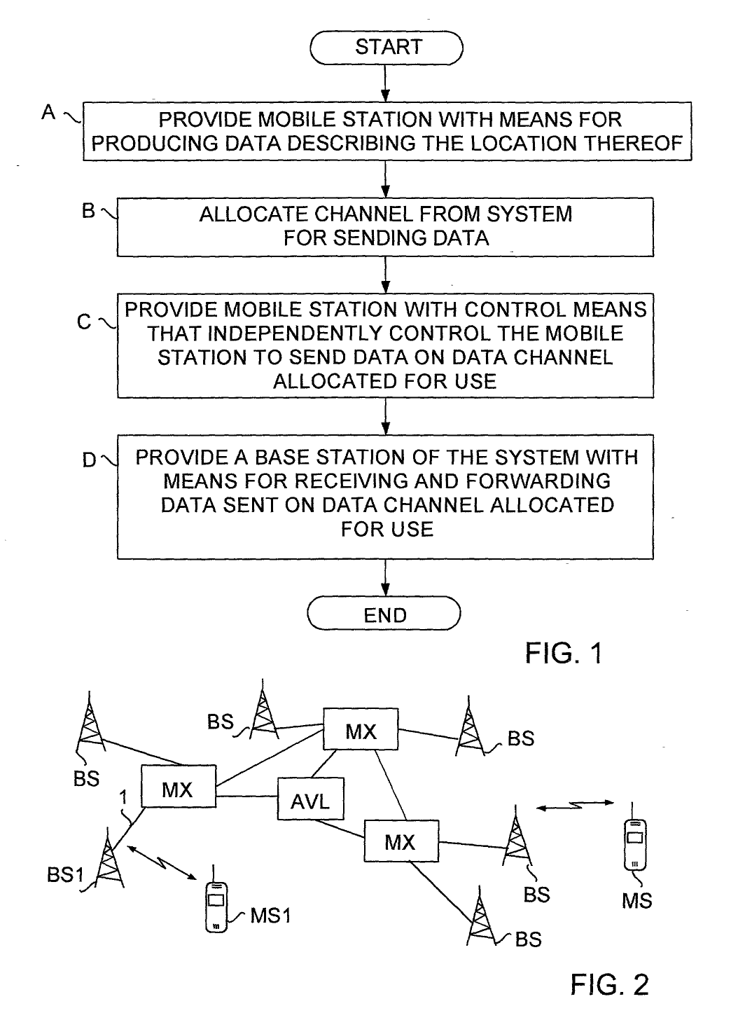

16. FIG. 1 is a flow chart showing a first preferred embodiment of the method of the invention,

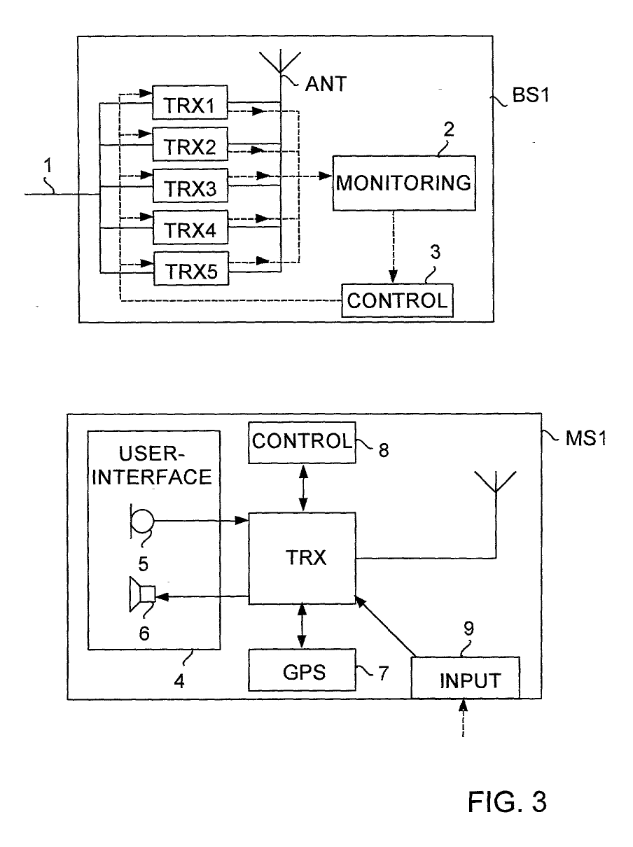

17. FIG. 2 is a block diagram showing a first preferred embodiment of the mobile communication system of the invention and

18. FIG. 3 is a block diagram illustrating a mobile station and a base station of FIG. 2.

19. FIG. 1 is a flow chart showing a first preferred embodiment of the method of the invention. In the embodiment shown in FIG. 1 the data sent by mobile stations on a data channel is composed of data describing the location thereof.

20. In block A the mobile station is provided with means for producing data describing the location thereof. Any means may be concerned which enable to locate the mobile station. An example of such means is the GPS receiver which allows to determine the location of the mobile station using a GPS location system based on satellites.

21. In block B a data channel is allocated from the system for sending data, for example data describing the location of the mobile station. There may be more than one data channel. The data channels can be fixedly programmed into the mobile stations or they may be indicated separately or in groups through calling channels. Data transmission can be initiated or stopped using commands transmitted through the calling channel.

22. In block C control means are arranged into the mobile station that independently control the mobile station to send data on the data channel that may include data describing the location thereof. To independently send refers in this context to a control unit which is programmed to select the time of transmission without the other parts of the network constantly having to command each individual mobile station by using control messages to send data describing the location. In accordance with the invention the control unit can directly control the mobile station to move to the channel used for sending the data and to send the data describing the location without having to allocate the channel used for sending the data in advance.

23. The calls arriving from the other parts of the system are repeated if necessary, which is why the mobile station may exit the calling channel for a short period of time (for the time the data is transmitted on the data channel) and still detect the call intended for the mobile station.

24. In block D the base station of the mobile communication system is provided with means for receiving and forwarding the data sent on the data channel. When data including location data of the mobile station is concerned, the base station forwards the data through a mobile exchange of the system to an application processing the location data. Said means may comprise a totally conventional transceiver unit, through which the base station may transmit traffic connections to the mobile station. In practice, any of the transceiver units of the base station can be directed to use the data channel, by which the mobile stations send data. However, if the traffic load of the base station increases to such an extent that the transceiver units used for providing common traffic connections (such as calls) cannot handle all connections, the base station controller of the system may direct the transceiver unit using the data channel at a particular moment to use one of the channels of the base station allocated for traffic use (a channel which has until then been unused) in such a manner that calls can be transmitted also through this transceiver unit. When one of the transceiver units of the base station is thereafter released (i.e. calls are no longer transmitted through it) said released transceiver unit is directed to use the data channel.

25. In accordance with the invention one of the base stations in the system may use the data channel allocated for sending data also as a traffic channel. In order to enable this the mobile stations can be programmed to check before the data is sent that there is no traffic on the channel in question. Interferences caused to neighbouring base stations can thus be avoided.

26. FIG. 2 is a block diagram showing a first preferred embodiment of the mobile communication system of the invention, and FIG. 3 is a block diagram illustrating a mobile station MS1 and a base station BS1 of FIG. 2. The mobile communication system in FIG. 2 can be, for example, a part of an Actionet radio system.

27. FIG. 2 shows three mobile exchanges MX providing connections through base stations BS and BS1 to mobile stations MS and MS1 located in the coverage area of the system. In accordance with the invention the mobile stations MS and MS1 send data over the radio path that is transmitted through the base stations to the mobile exchanges MX, and from there further to applications utilizing said data. The data sent by the mobile stations can be, for example, telemetry data describing a measured variable such as water-level elevation or traffic density. However, in the case shown in FIG. 2, it is assumed by way of example that the data in question is composed of data describing the location of the mobile station, the mobile stations sending said data over the radio path through the base stations to the mobile exchanges MX. The mobile exchanges MX are, in turn, provided with adapters through which the data describing the location can be forwarded to an application utilizing the data, such as a monitoring centre AVL (Automatic Vehicle Location) for further processing.

28. A specific data channel for sending data from the mobile station to the base stations is allocated for use in the mobile communication system shown in FIG. 2. In this case it is assumed that all base stations BS and BS1 receive the data sent on said data channel, whereafter the base stations forward the data to monitoring units through mobile exchanges, Correspondingly all mobile stations MS and MS1 in FIG. 2 use said channel for sending the data describing location. However, in contrast to the case shown in FIG. 2, more than one data channel may be used. This is advantageous particularly if the amount of data to be sent is large, and a single data channel is not capable of transmitting the entire amount of data.

29. FIG. 3 shows in greater detail the structure of the base station BS1 shown in FIG. 2. The base station BS1 comprises an antenna ANT and five transceiver units. In FIG. 3 it is assumed that four transceiver units TRX1-TRX4 are arranged to use the channels allocated for the traffic use of the base station, through which the base station provides calls to the mobile stations located in the coverage area thereof. In the case shown in FIG. 3 the fifth transceiver unit TRX5 of the base station BS1 is arranged to use a data channel, by which the mobile stations send data composed of data describing location. The base station BS1 forwards the data received by the transceiver unit TRX5 to the mobile exchange through a data transmission connection 1.

30. In addition to the channels mentioned above allocated for traffic use and the data channels, the base station in FIG. 3 employs the control channels/signaling channels and calling channels of the system in a manner known per se. Depending on the application object the base station may have separate transceiver units for utilizing said channels, or alternatively the base station may utilize one or more of the transceiver units shown in FIG. 3 in connection with the other channels.

31. The base station BS1 further comprises monitoring means 2 enabling the base station to observe the operation of the transceiver units TRX1-TRX4. If the monitoring means 2 detect that the traffic load of the base station is so large that the base station BS1 cannot reliably and accurately attend to it by means of the transceiver units TRX1-TRX4, the monitoring unit 2 informs the control unit 3 about this. In practice this may occur, for example, when the monitoring unit 2 detects that the number of calls transmitted by the transceiver units TRX1-TRX4 exceeds a predetermined threshold value. When the control unit 3 receives said information from the monitoring unit 2, the control unit sends a control signal to the transceiver unit TRX5 which affects the transceiver unit TRX5 in such a manner that the TRX5 starts using a still available channel that is allocated for the traffic use of the base station BS1. After this traffic connections can also be provided through the transceiver unit TRX5.

32. When all the transceiver units TRX1-TRX5 of the base station BS1 use the channels allocated for the traffic use of the base station, said base station BS1 is not able to receive the data received on the data channel. However, in such a situation the monitoring unit observes the operation of the transceiver units TRX1-TRX5, and immediately when the monitoring unit detects that one of the transceivers is released (no calls are transmitted through the one), the monitoring unit informs the control unit 3 about this. The control unit 3 then directs the released transceiver unit to start using a data channel, in which case the base station BS1 is again able to receive the data sent by the mobile station.

33. The mobile station MS1 in FIG. 3 comprises a transceiver unit TRX and a user interface 4 including a loudspeaker 6 and a microphone 5. The mobile station MS1 in FIG. 3 also comprises a GPS receiver 7 which generates data describing the location of the mobile station, or in practice the co-ordinates indicating the position of the mobile station.

34. The control unit 8 of the mobile station is programmed to control the transceiver unit TRX of the mobile station MS1 in such a manner that the transceiver unit TRX sends at determined moments the data describing the location produced by the GPS receiver 7 on the channel allocated for said purpose in the system. The transmission may take place, for example, 2-3 times per minute. The transmission of data may occur, for example, using a message according to the MPR 1343 SDM (Short Data Message) format, which is preferably compressed beneath 128 bits. When said message is sent the transceiver unit TRX returns by control of the control unit 8 to the original channel without waiting for an acknowledgement. When no traffic connection exists the transceiver unit TRX returns to listen to the calling channel of the system.

35. In accordance with the invention the mobile stations of the mobile communication system can be arranged into groups so that a regularly repeated period of time, for example 5 seconds, is determined for each group, and during this time the mobile stations of said group should send data, i.e. for instance the data describing the location thereof, on the data channel allocated for this purpose. Such a 5 second time period allocated for a particular mobile station group may be repeated every third minute, for example. The base stations of the system can send, for example on the control channels, data for different mobile station groups about how they should time the transmission of the data describing the location. On the basis of said data the control unit 8 of the mobile station MS1 attends to the transmission time of the data describing the location.

36. The mobile station MS1 in FIG. 3 also comprises an input 9 through which the mobile station can be connected to an apparatus providing telemetry data. Therefore the mobile station MS1 can receive the telemetry data of said apparatus, in which case the telemetry data is fed further to the transceiver unit TRX of the mobile station. Said telemetry data can then include data sent on the data channel of the mobile station MS1, the control unit 8 of the mobile station deciding upon the transmission time of said data. Examples of possible telemetry data to be sent are the water-level elevation indicated by an apparatus measuring water-level elevation or alternatively the traffic density indicated by an apparatus measuring traffic density on a highway.

37. The exact transmission time of the data sent by the mobile station can be synchronized with the signaling of the calling channel of the mobile communication system. Then the mobile stations receive signals sent on the calling channel and the control units thereof select the transmission time of the data by taking into account the reception time of the received signals.

38. If the location of the mobile stations is based on the GPS system, the base stations BS and BS1 of the mobile communication system preferably send DGPS data on the calling or control channel of the system. The mobile station MS1 thus receives the DGPS data among other data transmitted on the calling or control channel, whereafter the DGPS data is used for obtaining a better accuracy of the location indicated by the GPS receiver 7. The DGPS data is based on using such a GPS receiver, whose location is accurately known. Said receiver is thus able to measure the error of the GPS signal received, i.e. the difference between the actual location thereof and the location indicated by the GPS signal. On the basis of said difference a DGPS signal is generated that is sent to the other GPS receivers, so that these can correct the error observed in the received GPS signal.

39. It is understandable that the above description and the Figures attached thereto are merely intended to illustrate the present invention. It is obvious for those skilled in the art that the invention can be modified in various ways without deviating from the scope and spirit of the invention presented in the attached claims.

What is claimed is:

1. A method for transmitting data from mobile stations to other parts of a mobile communication system in the mobile communication system comprising base stations having a data transmission connection with a mobile exchange and mobile stations comprising transmission means for sending data, characterized by comprising the steps of
allocating at least one predetermined data channel from the system for sending said data over the radio path from the mobile stations to the base stations,
providing at least one mobile station with control means that independently at predetermined moments control the mobile station to send data on said data channel without a channel allocation preceding the transmission, and
providing at least one of the base stations in the system with means for receiving the data sent on said data channel and for forwarding said data to the other parts of the system.

2. A method as claimed in claim 1, characterized by
providing at least one of said mobile stations belonging to the system with means for producing data describing the location thereof, whereby the data sent by said mobile station at said predetermined moments includes the data describing the location of the mobile station,
arranging an application having a data transmission connection with said mobile exchange to the mobile communication system for processing the location data of the mobile stations, and
providing said at least one base station of the system with means for sending the data received from said at least one mobile station through the mobile exchange to said application.

3. A method as claimed in claim 1, characterized by connecting at least one mobile station belonging to the system to means for providing telemetry data, whereby the data sent by said mobile station at said predetermined moments includes the telemetry data provided by said means.

4. A method as claimed in any one of claims 1 to 3, characterized in that the control means of the mobile station control the mobile station to move at regular intervals onto said data channel for sending data.

5. A method as claimed in any one of claims 1 to 3, characterized by
dividing the mobile stations of the system into groups, and
determining a time period recurring at predetermined regular intervals for the mobile station groups, during which time period the control means of the mobile stations in the mobile station group control the mobile stations to move onto said data channel for sending said data.

6. A mobile communication system including:
mobile stations (MS1) comprising transmission means (TRX) for sending data over the radio path,
at least one mobile exchange (MX), and
base stations (BS, BS1) having a data transmission connection with the mobile exchange (MX), traffic channels being allocated to be used by transceiver units (TRX1-TRX5) of the base stations for providing calls to the mobile stations (MS, MS1), the base stations also comprising means for receiving data sent by the mobile stations over the radio path and for forwarding said data to other parts of the system, characterized in that
at least one predetermined data channel is allocated in the system for the mobile stations (MS, MS1) to send data, and in that
the system includes at least one mobile station (MS1) comprising control means (8) that independently at predetermined moments control the transmission means (TRX) of the mobile station to move to said predetermined data channel for the time data is sent, in which case the mobile station (MS1) sends said data on said data channel without a preceding channel allocation.

7. A mobile communication system as claimed in claim 6, characterized by
said mobile station (MS1) comprising means (7) for providing data describing the location of the mobile station and feeding said data to said transmission means (TRX), whereby the data sent on said data channel of the mobile station describes the location of the mobile station,
the system comprising an application (AVL) having a data transmission connection with the mobile exchange for processing the location data of the mobile station and
the base stations (BS, BS1) of the system being arranged to send the data received from the mobile stations through the mobile exchange (MX) to said application (AVL).

8. A mobile communication system as claimed in claim 7, characterized in that said means (7) for providing the data describing the location of the mobile station comprise a GPS receiver.

9. A mobile communication system as claimed in claim 8, characterized by comprising at least one base station (BS1) including means for sending DGPS data to the mobile stations on a calling channel or control channel used by the system.

10. A mobile communication system as claimed in claim 6, characterized by said mobile station (MS1) comprising means (9) for receiving telemetry data from means providing telemetry data, and means for feeding the received telemetry data to said transmission means (TRX) for forwarding the telemetry data on the data channel, whereby the data sent on the data channel by said mobile station (MS1) consists of said telemetry data.

11. A mobile communication system as claimed in any one of claims 6 to 10, characterized by the control means (8) of said mobile station (MS1) controlling the transmission means (TRX) of the mobile station to move at regular intervals onto said data channel for sending said data.

12. A mobile communication system as claimed in any one of claims 6 to 10, characterized by
said mobile station comprising means for receiving signals sent on the calling channel of the system, and
the control means (8) of said mobile system controlling the transmission means (TRX) of the mobile station to move onto said data channel for sending said data at times which are synchronized with the reception times of the signals received from the calling channel.

13. A mobile communication system as claimed in any one of claims 6 to 10, characterized by
the mobile stations (MS, MS1) of the system being divided into groups, and
a predetermined time period repeated at regular intervals being defined for said mobile station groups, during which time period the control means (8) of mobile stations (MS1) of a mobile station group control the transmitters of the mobile stations to move onto the data channel for sending said data.

14. A mobile communication system as claimed in any one of claims 6 to 13, characterized by at least one of said base stations (BS1) comprising:
at least one transceiver unit (TRX5) arranged to use said data channel for receiving the data sent by the mobile stations,
transceiver units (TRX1-TRX4) arranged to use the traffic channels allocated to be used by said base station (BS1) for transmitting calls between the mobile stations (MS, MS1) located in the coverage area of the base station (BS1) and the mobile exchange (MX),
monitoring means (2) arranged to monitor the traffic load of the transceiver units (TRX1-TRX4) using the traffic channels, and
control means (3) controlling the transceiver unit (TRX5) using the data channel to use a traffic channel allocated to be used by the base station (BS1), when the control means (3) indicate that the traffic load of the base station exceeds the predetermined limit, and which direct a transceiver unit (TRX1-TRX5) released from traffic use to use the data channel, when the monitoring means (2) indicate that the transceiver unit to be released is not needed for traffic channel use.

15. A mobile communication system as claimed in any one of claims 6 to 14, characterized by
a plurality of predetermined data channels being allocated for use, by which the mobile stations (MS, MS1) send data, and
comprising at least one base station including means for indicating the data channel to be used for said at least one mobile station (MS1) using a message sent on the calling channel of the system.
